(19) United States
(12) Patent Application Publication
(10) Pub. No.: US 2005/0005573 A1
(43) Pub. Date: Jan. 13, 2005

(54) Fly-ash based seamless masonry mortar

(76) Inventor: William M. Strabala, Arvada, CO (US)

Correspondence Address: SHERIDAN ROSS PC, 1560 BROADWAY, SUITE 1200, DENVER, CO, 80202, US

(21) Appl. No.: 10/887,284

(22) Filed: Jul. 7, 2004

Related U.S. Application Data
(60) Provisional application No. 60/485,592, filed on Jul. 7, 2003.

(51) Int. Cl. C04B 14/00

(52) U.S. Cl. 52/745.19

(57) ABSTRACT

The non-combustible natural minerals of fly ash, as a constituent of combustion of coal or other carbonaceous or cellulose fuels, are combined in an aqueous mixture with a man-made binder to form a thin paste which has adhesive qualities in the joining of masonry products such as cementitious blocks, clay bricks, or pozzolanic structural materials. The resultant bonding agent is intended to eliminate the need for visually obvious mortar seams, allow “dry stacking” of the building blocks, and usually will not contain any significant portion of either portland cement or sticky adhesives (as derived from petroleum products exhibiting Volatile Organic Compounds). In use, the material creates a “seamless” look to otherwise-conventional structural masonry walls. In effect, such walls can be built with less expenditure of time, labor and materials and with as much or more strength than conventional masonry or wooden stud walls, and with increased safety from fire hazards, weather and wind ingress under the “dry stacking” regimen.

### RELATED APPLICATION

This application claims priority from U.S. Provisional Patent Application No. 60/485,592 filed on Jul. 7, 2003. The entire disclosure of the provisional application is considered to be part of the disclosure of the accompanying application and is hereby incorporated by reference.

### FIELD OF THE INVENTION

The present invention is directed to the use of fly ash, a waste byproduct of energy production, as a building material useful in the construction of homes, offices and other structures especially where the bonding of discrete blocks, bricks, panels or other masonry units are concerned.

### BACKGROUND AND SUMMARY OF THE INVENTION

Whereas most masonry products such as bricks and concrete blocks require an artful, time-consuming and expensive skill in the mixing of cementitious mortars and application of the same between the composite joints within such a wall, the present invention allows for a quick method of wall building by “dry stacking” such composites in a self-leveling manner.

The present invention, which may become commercially known as “Instead-Of-Mortar” (hereinafter “10M”), can be applied from a pressure-gun instead of a hand-trowel in a thin bead along the contact surfaces being joined. The IOM is quick-setting and has self-leveling properties where its interactions with the bricks/block are concerned, minimizing the need to achieve manually-leveled rows of mortar seams.

These novel features of the present invention eliminate the need for mixing and resupply of sand-and-portland mortar, and the time-consuming skill of trowel-leveling each rank of blocks or bricks.

In addition, because the current invention uses waste materials instead of commercial products that require energy-consumptive pre-use methods of mining, kilning, lumbering and packaging, the current invention affords considerable relief from such environmental burdens of supplying raw materials for existing systems of wall construction while reducing the cost of such construction.

The present invention has special application in the implementation of technologies disclosed in U.S. Pat. Nos. 5,534,058 and 6,200,379-B1, previously granted to the current applicant, are concerned. That is, the present invention is conducive to the “dry stacking” process of the building materials protected by such prior patents and to the strength and weather-proofing of any wall so constructed.

At the same time, the present invention benefits include increased speed and reduced cost of construction of conventional masonry walls, and as described above.

### PREFERRED EMBODIMENTS OF THE INVENTION

One aspect of the present invention is directed to an article of fabrication and use that mixes the hydraulic powder known as fly ash with a liquid (e.g., water) and a binder. The resulting paste, of the approximate viscosity of tooth paste, is preferably extruded through a pressurized binary blending nozzle or some other means of conduction convenient to the “set time” of the IOM and conditions at the site of construction.

The ratio of water to binder in the liquid portion of the paste should preferably be in the range of 80-90 percent by weight of water. The ratio of the liquid portion to the dry ash portion in the paste should be in the range of 20-25 percent by weight of the liquid, adjustable at the discretion of the user's particular on-site application to account for the porosity, absorbability, weather, and other conditions experienced in any particular application.

The binder may include any number of commercial polymeric concrete, stucco or cement sealers or emulsifiers and additives, including but not limited to Duracet 7000. The fly ash may be of any rated class, including but not limited to, the “C-Class” and “F-Class” industry nomenclature.

The preferred water, binder and fly ash mixture of the present invention is preferably applied to masonry products (e.g., stone, brick, concrete blocks, etc.) in a relatively thin bead and/or layer, preferably less than the amount of mortar applied in a traditional and conventional sand/Portland cement mortar, more preferably less than about 1/4 inch, even more preferably, less than about 1/8 inch, and even more preferably, less than about 1/16 inch in thickness layer. The adjoining masonry products are configured and constructed with these thin layers of water/binder/fly ash (e.g., the IOM materials), preferably applied by use of a pressure gun-like device, rather than using a hand trowel (as used in conventional mortar applications). The structure is then allowed to dry a sufficient amount of time (at least about 3 hours, more preferably at least about 5 hours, and more preferably of at least about 10 hours) until the structure attains strength characteristics that are comparable, if not exceeding, those as found in conventional sand/Portland cement mortar constructed structures. The present invention results in masonry product structures that have strength characteristics (in terms of bonding between the masonry products themselves) that are comparable if not exceeding those of conventional sand/Portland cement mortars, petroleum-based adhesives and other conventional masonry units and/or structural walls constructed with prior art mortars. One of the advantages of the present invention is that a seamless appearance can be achieved through the use of masonry products while still retaining the desired strength and adhesion characteristics of traditional mortar constructed walls.

The non-combustible natural minerals of fly ash, as a constituent of combustion of coal or other carbonaceous or cellulose fuels, are combined in an aqueous mixture with a man-made binder to form a thin paste which has adhesive qualities in the joining of masonry products such as cementitious blocks, clay bricks, or pozzolanic structural materials. The resultant bonding agent is intended to eliminate the need for visually obvious mortar seams, allow “dry stacking” of the building blocks, and usually will not contain any significant portion of either portland cement or sticky adhesives (as derived from petroleum products exhibiting Volatile Organic Compounds). In use, the material creates a “seamless” look to otherwise conventional structural masonry walls. In effect, such walls can be built with less expenditure of time, labor and materials and with as much or more strength than conventional masonry or wooden stud walls, and with increased safety from fire hazards, weather and wind ingress under the “dry stacking” regimen.

While various embodiments of the present invention have been described in detail, it will be apparent that further modifications and adaptations of the invention will occur to those skilled in the art. It is to be expressly understood that such modifications and adaptations are within the spirit and scope of the present invention.

1. A method for constructing a masonry structure, comprising:
providing a mixture of water, binder and fly ash;
applying said mixture with a pressure-gun device in a substantially thin bead and/or layer along contact surfaces of adjoining masonry products, such masonry products selected from the group consisting of bricks, stone and concrete;
placing adjacent masonry products in contact with said bead or layer; and
permitting said mixture of water, binder and fly ash to dry, whereby a resulting structure has strength characteristics comparable to structures constructed using conventional sand-and-Portland cement mortar.

2. The method as set forth in claim 1, wherein said bead and/or layer is less than about 1/8th inch thick.
